(19) United States
(12) Patent Application Publication
(10) Pub. No.: US 2006/0243216 A1
(43) Pub. Date: Nov. 2, 2006

(54) Nonabsorbent animal care product

(76) Inventor: Delia Cuellar, Houston, TX (US)

Correspondence Address: ARNOLD & FERRERA, L.L.P., 2401 FOUNTAIN VIEW DRIVE, SUITE 630, HOUSTON, TX, 77057, US

(21) Appl. No.: 11/409,842

(22) Filed: Apr. 24, 2006

Related U.S. Application Data
(60) Provisional application No. 60/674,464, filed on Apr. 25, 2005.

(51) Int. Cl. A01K 1/015

(52) U.S. Cl. 119/526

(57) ABSTRACT

Provided herein is a system and method for containing wastes from animals, the method using nonabsorbent paper material. Nonabsorbent paper is dispensed from a boxed container, the container having central perforations on a first side forming a first dispensing slot and length-wise perforations on a second side forming a second dispensing slot, whereby the non-absorbent paper may be dispensed from the boxed container. The non-absorbent paper may be ink free and hypoallergenic.

### STATEMENT OF RELATED CASES

This application claims the benefit of prior U.S. Provisional Application No. 60/674,464, filed Apr. 25, 2005.

### FIELD OF THE INVENTION

The present invention relates generally to products used to gather and contain animal wastes and, more specifically, to the use of non-absorbent materials for gathering and containing animal wastes.

### BACKGROUND OF THE INVENTION

The present invention comprises a new field of use for combinations of previously known paper-type products, especially those paper-type products that are relatively inexpensive, durable and nonabsorbent.

In particular, a practical, novel and non-obvious manner of using single fold and multifold wax “deli paper” (e.g., Kabnet Wax Paper manufactured by Georgia Pacific or Marcal Paper Mills'0 rolled wax paper and/or interfolded wax paper) is contemplated, in which essentially nonabsorbent paper-type products are used to gather and contain animal waste, droppings from food, etc.

In a presently preferred embodiment, for example, twelve-inch by ten-and-three-quarter inch Kabnet Wax Paper is used to line cages and other animal confinement environs, such as dog and cat carriers, etc., so that waste and/or other particulate created by the animal and/or its food supply can be gathered and removed from the confinement without the need for extensive cleaning and scrubbing of the surfaces disposed beneath the paper. In this manner, waste removal and the like are carried out quickly and easily.

Advantages of the invention include a diminution of cost and labor associated with the cleaning and maintenance of animal pens and cages, and an associated health benefit for animals housed in confinements in which the invention is practiced. Consequently, owners and vendors of both animals and their housings are relieved of the need to collect and install multiple layers of newspaper or another absorbent material in their pet housings, and the confines are made suitable for use and/or sale as soon after waste removal as possible.

### SUMMARY OF THE INVENTION

According to a first set of examples of the invention, there is provided a method for containing waste from animals including the use of a substantially nonabsorbent paper material.

According to another example of the invention, the nonabsorbent paper material of the above method for containing waste from animals comprises a wax paper.

According to another example of the invention, the nonabsorbent paper material of the above method for containing waste from animals comprises a folded wax paper.

According to another example of the invention, the nonabsorbent paper material of the above method for containing waste from animals comprises a rolled paper.

According to another example of the invention, the nonabsorbent paper material of the above method for containing waste from animals comprises a paper waxed on one side.

According to another example of the invention, the nonabsorbent paper material of the above method for containing waste from animals comprises a wax paper substantially free of ink.

According to another example of the invention, the nonabsorbent paper material of the above method for containing waste from animals comprises a substantially hypoallergenic paper material.

According to another example of the invention, the nonabsorbent paper material of the above method for containing waste from animals comprises a paper material, waxed on one side, and cut to measure approximately twelve-inches by ten-and-three-quarter inches.

According to another example of the invention, the nonabsorbent paper material of the above method for containing waste from animals comprises a folded paper material, waxed on one side, cut to measure approximately twelve-inches by ten-and-three-quarter inches.

According to another example of the invention, the nonabsorbent paper material of the above method for containing waste from animals comprises a folded paper material, waxed on one side, cut to measure approximately twelve-inches by ten-and-three-quarter inches, wherein said paper material is dispensed or withdrawn from a boxed container.

According to another example of the invention, the boxed container of the above method for containing waste from animals comprises one or more longitudinal perforations that form a product-dispensing slot, wherein the nonabsorbent paper material is dispensed from within said boxed container.

According to another example of the invention, the boxed container of the above method for containing waste from animals comprises one or more central perforations that together form a dispensing slot, wherein a nonabsorbent paper material is dispensed from within the boxed container.

According to another example of the invention, the boxed container of the above method for containing waste from animals comprises one or more central perforations disposed on a first side of the boxed container, thereby forming a first dispensing slot, wherein the nonabsorbent paper material is dispensed from within the boxed container; and one or more longitudinal perforations disposed on a second side of the boxed container, thereby forming a second dispensing slot.

According to another example of the invention, the above method for containing waste from animals further comprises a step of applying the nonabsorbent paper material on the floor surface of an animal confinement area.

According to a second set of examples of the invention, there is provided a method for containing waste from animals, the method having the steps of: dispensing a non-absorbent receiving material from a receptacle; disposing the non-absorbent receiving material in an animal waste containment area; accumulating animal waste on the non-absorbent receiving material in the animal waste containment area; collecting the non-absorbent receiving material containing the animal waste accumulation from the animal waste containment area; and disposing the non-absorbent receiving material containing the animal waste accumulation.

According to a third set of examples of the invention, there is provided a disposable animal waste containment system having a means for dispensing a non-absorbent receiving material; a means for disposing said non-absorbent receiving material in an animal waste containment area; a means for accumulating animal waste on said non-absorbent receiving material in said animal waste containment area; a means for collecting said non-absorbent receiving material containing said animal waste accumulation from said animal waste containment area; and a means for disposing said non-absorbent receiving material containing said animal waste accumulation.

According to another example of the invention, the means for dispensing of the above described disposable animal waste containment system further has a boxed container that has length-wise perforations forming a dispensing slot, whereby the non-absorbent receiving material may be dispensed from the boxed container.

According to another example of the invention, the means for dispensing of the above described disposable animal waste containment system further has a boxed container that has central perforations forming a dispensing slot, whereby the non-absorbent receiving material may be dispensed from the boxed container.

According to another example of the invention, the means for dispensing of the above described disposable animal waste containment system further has a boxed container which further has central perforations on a first side of the boxed container forming a first dispensing slot, whereby the non-absorbent receiving material may be dispensed from the boxed container; and length-wise perforations on a second side of the boxed container forming a second dispensing slot, whereby the non-absorbent receiving material may be dispensed from the boxed container.

### BRIEF DESCRIPTION OF SEVERAL DRAWINGS

FIG. 1 is a perspective view of an example of the present invention, comprising a disposable animal waste containment system having length-wise perforations forming a dispensing slot, thereby dispensing a non-absorbent receiving material.

FIG. 2 is a perspective view of an example of the present invention, comprising a disposable animal waste containment system having central perforations forming a dispensing slot, thereby dispensing a non-absorbent receiving material.

FIG. 3 is a perspective view showing application of the present invention, including disposing a non-absorbent receiving material in an animal waste containment area.

### DETAILED DESCRIPTION

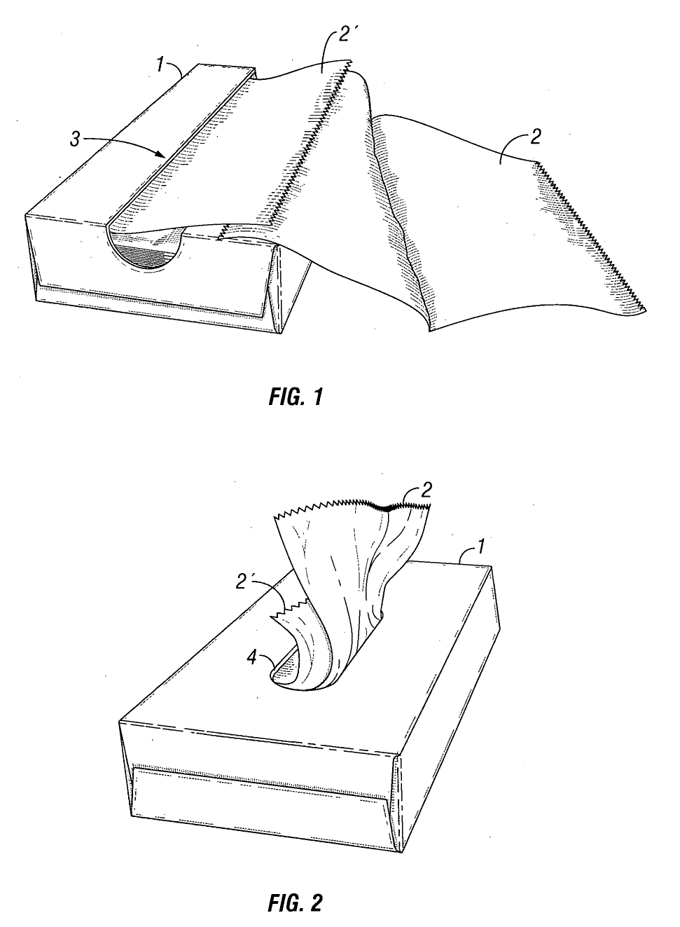

Each of FIGS. 1-3 illustrates a system and method for containing wastes from animals embodying various aspects of the present invention. These particular examples are illustrated and described herein for exemplary purposes. Variations of the system and methods of utilizing the same according to the invention will become readily apparent to one skilled in the relevant structural or mechanical arts upon reading the present Description and/or viewing the accompanying Drawings. Thus, the present invention is not limited only to the structures, systems, and methods described below.

FIG. 1 illustrates a perspective view of an example of the present invention, including a disposable animal waste containment system having length-wise perforations forming a dispensing slot, thereby dispensing a non-absorbent receiving material. Boxed container 1 is used as a means for dispensing nonabsorbent paper material 2, 2′. Boxed container 1 may be made of any of a number of various materials, such as cardboard, plastic, or a bag-like plastic dispensing unit. Boxed container 1 further has length-wise perforations 3 along one side of boxed container 1, thereby forming a dispensing slot. Nonabsorbent paper material 2 may be unfolded as it is pulled out from boxed container 1, thereby making the next sheet of nonabsorbent paper material 2′ available for dispensing. Nonabsorbent paper material 2, 2′ may be any of a variety of materials exhibiting a quality of substantially limited absorbent ability, such as materials coated with a hydrophobic substance. Examples of nonabsorbent paper material 2, 2′ include: wax paper, folded wax paper, rolled hydrophobic paper, and paper waxed on one side.

In a further example, nonabsorbent paper material 2, 2′ is devoid of inks so as to provide a level of protection to animals that may be allergic to printing inks. Further, nonabsorbent paper material 2, 2′ that is devoid of inks provides a uniform observing surface so a user may easily monitor an animals' waste for indications of sickness or digestion anomalies.

In another example, nonabsorbent paper material 2, 2′ may be manufactured to hypoallergenic standards, offering further protection to sensitive animals and eliminating exposure to organic and/or inorganic toxins that may be present in some printing inks.

In a preferred example, nonabsorbent paper material 2, 2′ is a folded paper waxed on one side, approximately twelve-inch by ten-and-three-quarter inch.

FIG. 2 illustrates a perspective view of an example of the present invention, a disposable animal waste containment system having central perforations forming a dispensing slot, dispensing a non-absorbent receiving material. Boxed container 1 is used as a means for dispensing nonabsorbent paper material 2, 2′. Boxed container 1 further has central perforations 4 on one side of boxed container 1, thereby forming a dispensing slot. Nonabsorbent paper material 2 may be seized as it is pulled out from boxed container 1, and the next sheet of nonabsorbent paper material 2′ rendered partially pulled out and otherwise made available for dispensing.

In a preferred example, central perforations 4 are placed on a first side of the boxed container 1 forming a first dispensing slot, and length-wise perforations 2 (as illustrated in FIG. 1) are placed on a second side of boxed container 1, forming a second dispensing slot.

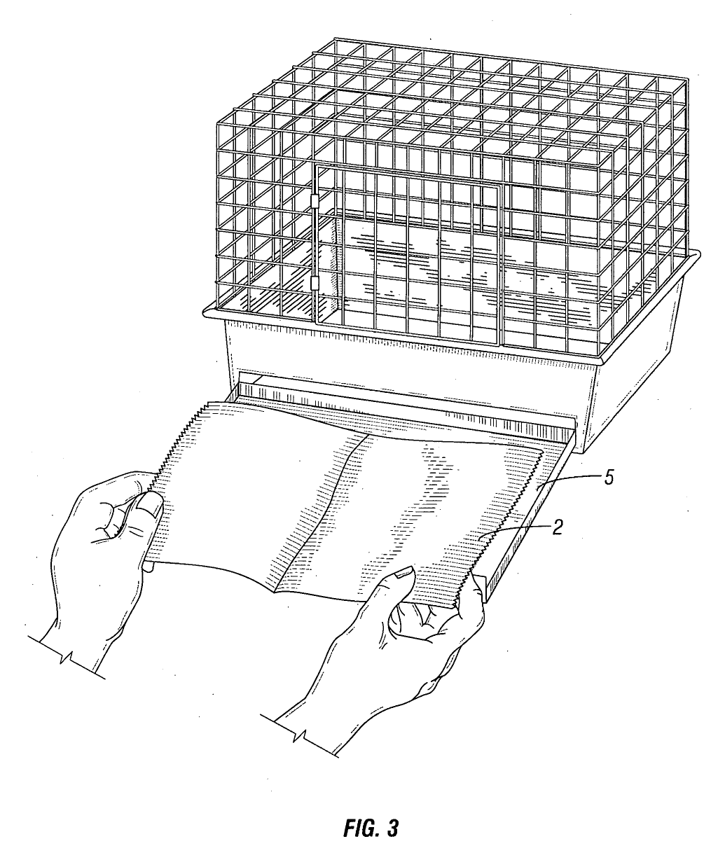

FIG. 3 illustrates a perspective view showing application of the present invention, disposing the non-absorbent receiving material in an animal waste containment area. An animal waste containment area 5 is accessed to receive one or more sheets of nonabsorbent paper material 2. Animal waste containment area 5 may be a cage, tray, kennel, or other such animal visitation area. Nonabsorbent paper material 2 typically is applied beneath an animal visitation area. Nonabsorbent paper material 2 receives animal excrement, or food droppings, as such excrement or dropping falls when left by an animal who is visiting, or housed in, animal containment area 5.

In operation, a non-absorbent receiving material 2 is dispensed from a receptacle, such as boxed container 1. Non-absorbent receiving material 2 is disposed in an animal waste containment area 5. Animal waste, such as excrement or food droppings, accumulates on non-absorbent receiving material 2 in animal waste containment area 5. Non-absorbent receiving material 2, now containing the animal waste, is collected from animal waste containment area 5. This may be accomplished by picking up non-absorbent receiving material 2 by the edges or corners and joining together one or more edges or corners to form a temporary bag-like structure. The non-absorbent receiving material 2 containing the animal waste accumulation is then disposed.

The foregoing description is presented for purposes of illustration and description, and is not intended to limit the invention to the forms disclosed herein. Consequently, variations and modifications commensurate with the above teachings and the teaching of the relevant art are within the spirit of the invention. Such variations will readily suggest themselves to those skilled in the relevant structural or mechanical art. Further, the embodiments described are also intended to explain the best mode for practicing the invention, and to enable others skilled in the art to utilize the invention and such or other embodiments and with various modifications required by the particular applications or uses of the invention. It is intended that the appended claims be construed to include alternative embodiments to the extent that is permitted by prior art.

1. A method for containing wastes from animals, wherein said method comprises containing waste from animals using a nonabsorbent paper material.

2. The method of claim 1, wherein said nonabsorbent paper material is a wax paper.

3. The method of claim 1, wherein said nonabsorbent paper material is a folded wax paper.

4. The method of claim 1, wherein said nonabsorbent paper material is a rolled hydrophobic paper.

5. The method of claim 1, wherein said nonabsorbent paper material is a paper waxed on one side.

6. The method of claim 1, wherein said nonabsorbent paper material is a substantially ink free papers material.

7. The method of claim 1, wherein said nonabsorbent paper material is substantially hypoallergenic.

8. The method of claim 1, wherein said nonabsorbent paper material is a paper waxed on one side, cut to measure approximately twelve-inches by ten-and-three-quarter inches.

9. The method of claim 1 wherein said nonabsorbent paper material is a folded paper waxed on one side, cut to measure approximately twelve-inches by ten-and-three-quarter inches.

10. The method of claim 1, wherein said nonabsorbent paper material is a folded paper waxed on one side, cut to measure approximately twelve-inches by ten-and-three-quarter inches, further comprised of the step of dispensing said nonabsorbent paper from a boxed container.

11. The method of claim 10, wherein said boxed container further comprises length-wise perforations forming a dispensing slot, whereby said nonabsorbent paper material may be dispensed from said boxed container.

12. The method of claim 10, wherein said boxed container further comprises central perforations forming a dispensing slot, whereby said nonabsorbent paper material may be dispensed from said boxed container.

13. The method of claim 10 wherein said boxed container further comprises:
central perforations on a first side of said boxed container forming a first dispensing slot, whereby said nonabsorbent paper material may be dispensed from said boxed container; and
length-wise perforations on a second side of said boxed container forming a second dispensing slot, whereby said nonabsorbent paper material may be dispensed.

14. The method for containing waste from animals of claim 1, said method further comprising the step of applying said nonabsorbent paper material beneath an animal visitation area.

15. A method for containing animal waste comprising the steps of:
dispensing a non-absorbent receiving material from a receptacle;
disposing said non-absorbent receiving material in an animal waste containment area;
accumulating animal waste on said non-absorbent receiving material in said animal waste containment area;
collecting said non-absorbent receiving material containing said animal waste accumulation from said animal waste containment area; and
disposing said non-absorbent receiving material containing said animal waste accumulation.

16. A disposable animal waste containment system comprising:
means for dispensing a non-absorbent receiving material;
means for disposing said non-absorbent receiving material in an animal waste containment area;
means for accumulating animal waste on said non-absorbent receiving material in said animal waste containment area;
means for collecting said non-absorbent receiving material containing said animal waste accumulation from said animal waste containment area; and
means for disposing said non-absorbent receiving material containing said animal waste accumulation.

17. The disposable animal waste containment system of claim 16, wherein said means for dispensing comprises a boxed container further comprising length-wise perforations forming a dispensing slot, whereby said non-absorbent receiving material may be dispensed from said boxed container.

18. The disposable animal waste containment system of claim 16, wherein said means for dispensing comprises a boxed container further comprising central perforations forming a dispensing slot, whereby said non-absorbent receiving material may be dispensed from said boxed container.

18. The disposable animal waste containment system of claim 16, said means for dispensing comprises a boxed container further comprising:
central perforations on a first side of said boxed container forming a first dispensing slot, whereby said non-absorbent receiving material may be dispensed from said boxed container; and
length-wise perforations on a second side of said boxed container forming a second dispensing slot, whereby said non-absorbent receiving material may be dispensed from said boxed container.
